(19) United States
(12) Patent Application Publication
(10) Pub. No.: US 2004/0073721 A1
(43) Pub. Date: Apr. 15, 2004

(54) DMA Controller for USB and like applications

(75) Inventors: Lonnie C. Goff, Tempe, AZ (US); Brian Logsdon, Phoenix, AZ (US)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V.

(21) Appl. No.: 10/268,408

(22) Filed: Oct. 10, 2002

(51) Int. Cl. G06F 13/28

(52) U.S. Cl. 710/22

(57) ABSTRACT

Various enhancements may be made to a DMA controller to optimize the DMA controller for use in non-uniform DMA applications such as Universal Serial Bus (USB) applications. First, a DMA count register that is used to store a count value that controls the length of a data transfer over a DMA channel may be capable of being selectively disabled, such that when the DMA count register is disabled, a DMA control circuit may perform a data transfer independent of the DMA count register. An endpoint watchdog timer may also be coupled to a DMA control circuit and configured to generate an interrupt if no data is received by the DMA channel within a predetermined period of time. In addition, a DMA control circuit may incorporate partial word hold off functionality to delay transmission of a final word of data from a data packet if the final word is a partial word. Furthermore, a USB profile circuit may be coupled to the DMA control circuit and configured to control at least one operational parameter of the DMA control circuit to selectively optimize the DMA control circuit for use with a selected USB protocol among a plurality of USB protocols supported by the USB profile circuit.

### FIELD OF THE INVENTION

The invention is generally related to memory access and transfer, and in particular to direct memory access (DMA) controllers.

### BACKGROUND OF THE INVENTION

The transfer of data within a computer or other electronic system is often an integral factor in the performance of such a system. Irrespective of how fast the central processing unit (CPU) of a computer or electronic system is able process data, if data cannot be communicated to or from the CPU in a fast enough manner, system performance will necessarily suffer.

One technique that has been used to improve data transfer performance is known as direct memory access (DMA). DMA utilizes a dedicated controller or circuit to handle data transfers independent of a CPU, thus freeing the CPU to handle other tasks during a data transfer operation. Typically, DMA is used to transmit data between a memory and a peripheral or input/output (I/O) device such as an expansion card, a network port, a storage device, etc.

Conventional DMA controllers often require little effort from a CPU to handle a data transfer operation. Typically, a CPU is required to initialize a DMA controller to handle a particular transfer operation, e.g., by specifying the source and destination of the operation and the amount of data to be transferred. DMA control logic conventionally includes a byte counter that is initialized by the CPU with the total number of bytes of data to be transferred in a given operation.

Once a data transfer operation is started by the CPU, the DMA control logic will begin to transfer data without any further involvement of the CPU. During the data transfer operation, the DMA control logic decrements the byte counter as it transfers each byte of data, until the byte count reaches zero. At that point, the DMA control logic may signal an interrupt to the CPU to notify that the CPU that the data transfer operation is complete.

Many peripheral devices with which DMA is often utilized rely on relatively simple protocols. Some devices, for example, are character-based devices, which signal DMA control logic whenever they have characters available. The number of inbound characters to be transferred in such instances is typically rule-based (i.e., it is either a constant or it is dynamically defined by protocol). Other devices are block devices, which use a fixed block size to program the byte counter in the DMA control logic.

Other peripheral devices are not as simple. For example, the Universal Serial Bus (USB) specification defines a serial data transmission protocol for connecting peripheral devices to a computer. The USB specification was developed to support a wide range of peripheral devices, including displays, audio speakers, printers, keyboards, mice, network adapters, modems, etc. These devices all have different capabilities and data transmission characteristics, and as such, the USB specification defines a packet-based interface to envelop data in a standardized manner to support practically any type of peripheral device. Of note, however, is that the amount of information contained in any data packet communicated over a USB bus is neither consistent nor predictable.

In addition, the underlying USB Protocols are not simple. Under the USB 2.0 specification, for example, there are four communication protocols, referred to as control, bulk, interrupt and isochronous. The control protocol supports bi-directional data transfers. The interrupt and isochronous protocols are periodic in nature, and have a guaranteed delivery schedule, and the isochronous protocol cannot be throttled (i.e., it is a real-time protocol). Sustained data rates of 192 Mb/s on individual endpoints are possible.

Due to several particular nuances of the USB specification, conventional DMA control logic designs are not well suited for incorporation into the controllers for USB devices.

First, USB devices do not readily adapt to the paradigm of loading a byte count into a DMA byte counter and then automatically turning off the DMA control logic and terminating the data transfer operation when the byte count has been exhausted. Under the USB specification, the number of bytes that will be received in a single data packet is not guaranteed. Moreover, for real-time isochronous protocols, message lengths are irrelevant, and for periodic interrupt or non-periodic bulk and control protocols, message lengths are often not known when data is being received.

Since neither the total number of data byes in a message nor the number of bytes in a single packet of a message is consistently predictable, conventional USB implementations typically make the simplifying assumption of turning off the DMA control logic on a per-packet basis. By doing so, however, the amount of oversight required by the CPU is often increased, thus decreasing system performance.

Second, many CPU's are too slow to intervene with some USB-related DMA transfers. As noted above, the real-time isochronous protocol cannot be throttled, and supports sustained data rates up to 192 Mb/s. The maximum number of bytes that can be transferred in a single USB data packet is 1024 bytes, so at the maximum sustained rate, conventional DMA control logic within a USB controller can get turned off, on average, every 43 μs for each high-bandwidth endpoint that it services. An embedded real-time version of the Linux operating system, on the other hand, takes approximately 100 instructions and 50 accesses to a stack in order to vector program control to an interrupt handler routine and return. Depending upon processor and memory bus speed and cache size, this system overhead is typically in the 2 to 5 μs range, and does not even include the time it actually takes the interrupt handler to execute. This overhead represents only one endpoint, and even with a double buffered endpoint, conventional DMA control logic would need to be able to be restarted and complete a 1024 byte transfer within 17 μs, otherwise data could be lost. As a result, many CPU's cannot reliably intervene in high-bandwidth isochronous transfers.

Third, modern bus architectures can often spoil USB-related DMA data content. In particular, conventional DMA controllers are byte oriented, while most modern bus architectures are word-oriented. As a result, if the number of bytes received in a data packet is not a multiple of the bus word size, a conventional DMA controller performs a final word transfer with only partially valid data. The remainder of the data in the final word transfer is invalid, and as such, if the data is destined for a block device such as a mass storage device, software executing on the CPU would be required to save the size of the received packet, execute partial word adjustments (which can be very onerous), make any necessary block overflow adjustments and re-enable the DMA controller whenever a data transfer operation was complete. Such overhead is precisely the type of CPU overhead that DMA is intended to address, and as such, the degree of CPU oversight required to handle USB-related DMA transfers is undesirable.

As such, a significant need exists in the art for DMA control logic that addresses the aforementioned limitations of conventional DMA controller designs, and in particular, addresses the shortcomings that arise whenever such control logic is utilized in connection with USB-related data transfers and the like.

### Summary of the Invention

The invention addresses these and other problems associated with the prior art in providing a number of enhancements to a DMA controller, which may be used separately or cooperatively to optimize a DMA controller for use in non-uniform DMA applications such as USB-compatible applications. Through enhancing DMA control logic in the various manners described hereinafter, the amount and degree of oversight required from a CPU is substantially reduced, which frees a CPU to perform other operations concurrently with DMA transfer operations, and thus improves overall system performance.

Consistent with one aspect of the invention, for example, a DMA count register that is used to store a count value that controls the length of a data transfer over a DMA channel may be capable of being selectively disabled, such that when the DMA count register is disabled, a DMA control circuit may perform a data transfer independent of the DMA count register. Consistent with another aspect of the invention, an endpoint watchdog timer may be coupled to a DMA control circuit and configured to generate an interrupt if no data is received by the DMA channel within a predetermined period of time. In addition, consistent with another aspect of the invention, a DMA control circuit may incorporate partial word hold off functionality to delay transmission of a final word of data from a data packet if the final word is a partial word.

Furthermore, when a DMA control circuit is utilized in a USB application, a USB profile circuit may be coupled to the DMA control circuit and configured to control at least one operational parameter of the DMA control circuit to selectively optimize the DMA control circuit for use with a selected USB protocol among a plurality of USB protocols supported by the USB profile circuit.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of an apparatus incorporating a DMA controller consistent with the invention.

FIG. 2 is a block diagram of the principal USB-specific components in the DMA controller control logic for one of the DMA channels referenced in FIG. 1.

FIG. 3 is a flowchart illustrating the program flow of an endpoint initialization routine executed by the USB driver of FIG. 1.

FIG. 4 is a flowchart illustrating the program flow of an interrupt handler routine executed by the USB driver of FIG. 1.

### DETAILED DESCRIPTION

The herein-described embodiments utilize one or more enhancements to a DMA controller to optimize the performance of DMA transfer operations in nonuniform DMA applications such as USB-related applications, and in particular, applications that are compatible with the USB 2.0 specification. It will be appreciated, however, that the various enhancements described hereinafter may be utilized separately from one another. Moreover, the enhancements described herein may have utility in applications other than USB-compatible applications. Therefore, the invention is not limited to the particular implementations discussed herein.

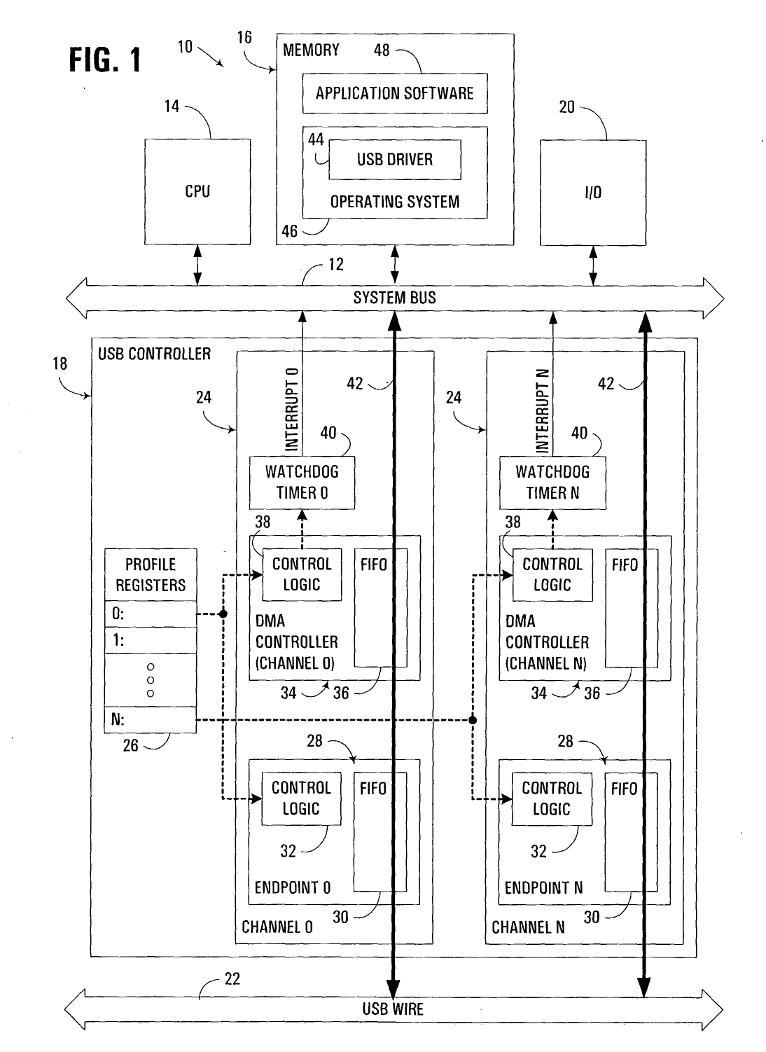

Turning now to the Drawings, wherein like numbers denote like parts throughout the several views, FIG. 1 illustrates an exemplary hardware and software environment for an apparatus 10 incorporating a DMA controller consistent with the invention. For the purposes of the invention, apparatus 10 may represent practically any type of computer, computer system or other programmable electronic device capable of serving as a USB host device, including a client computer, a server computer, a portable computer, a handheld computer, an embedded controller, etc. Apparatus 10 may also hereinafter be referred to as a “computer,” although it should be appreciated the term “apparatus” may also include other suitable programmable electronic devices consistent with the invention.

Moreover, it will be appreciated that a DMA controller consistent with the invention may also be utilized within a USB slave device. Furthermore, many of the features described herein may also be implemented in DMA controllers utilized in other memory transfer applications, including other USB specification versions, as well as a number of non-USB applications. Therefore, the invention is not limited to the particular USB host implementation described hereinafter.

Computer 10 typically includes a system bus 12 to which is coupled a central processing unit (CPU) 14 including one or more microprocessors coupled to a memory 16, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 16 may be considered to include memory storage physically located elsewhere in computer 10, e.g., any cache memory in a processor in CPU 14, as well as any storage capacity used as a virtual memory, e.g., as stored on a mass storage device or on another computer coupled to computer 10.

To provide USB connectivity, a USB controller 18 is additionally coupled to system bus 12. Furthermore, other input/output (I/O) functionality that may be utilized in computer 10, e.g., mass storage devices, network adapters, workstation adapters, peripheral input devices such as mice and keyboards, video displays and adapters, etc., are generically represented by I/O block 20, which is also shown coupled to system bus 12.

USB controller 18 as shown in compatible with the USB 2.0 specification, and generally interfaces system bus 12 with a USB wire 22, representing one or more USB networks. USB controller 18 defines a device port that typically supports one or more USB channels 24 (also denoted as channels 0 . . . N). Moreover, associated with each channel 24 is a profile register 26, which as will be discussed hereinafter, is used to configure each channel for optimum performance depending upon the particular type of data being transferred over the channel.

Each channel 24 includes an endpoint 28, within which is incorporated a first-in first-out (FIFO) buffer 30 under the control of a control logic circuit 32. Each channel 24 also includes a DMA controller 34 including a FIFO buffer 36 under the control of a DMA control logic circuit 38. Control logic circuit 38 also controls the operation of an associated watchdog timer 40, which is configured to issue an interrupt (interrupt 0) on system bus 12 as a result of a time-out condition.

The operation of the control logic circuits 32, 38 in each channel is customized based upon profile information stored in the profile register 26 associated with the channel 24. Once configured, circuits 32, 38 transmit data between USB wire 22 and a register or memory accessible over system bus 12, as shown by transfer paths 42, and in a manner that is consistent with the USB 2.0 specification.

It will be appreciated that USB controller 20 is typically implemented in a circuit arrangement incorporating one or more integrated circuit devices as well as additional supporting electronic components. For example, each DMA controller 34 may be implemented in the same or a different integrated circuit device as each endpoint 28, and the control circuitry for each channel may be implemented on the same or different integrated circuit devices. A USB controller may also be integrated with additional circuitry, e.g., system bus 12, CPU 14, memory 16, and/or I/O block 18, e.g., in a system on a chip (SOC) implementation.

Moreover, the DMA controller for each channel 24 may be considered to be a separate DMA controller, or logic circuitry within a single DMA controller.

As is well known in the art, integrated circuit devices are typically designed and fabricated using one or more computer data files, referred to herein as hardware definition programs, that define the layout of the circuit arrangements on the devices. The programs are typically generated by a design tool and are subsequently used during manufacturing to create the layout masks that define the circuit arrangements applied to a semiconductor wafer. Typically, the programs are provided in a predefined format using a hardware definition language (HDL) such as VHDL, verilog, EDIF, etc. While the invention has and hereinafter will be described in the context of circuit arrangements implemented in fully functioning integrated circuit devices and data processing systems utilizing such devices, those skilled in the art will appreciate that circuit arrangements consistent with the invention are also capable of being distributed as program products in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

From a software standpoint, support for USB device functionality is typically implemented within a USB driver 44, shown resident in memory 16 as a component of an operation system 46. USB data is typically utilized by various application software 48, as is well known in the art. Among other functions, USB driver 44 is capable of configuring each channel 24 of USB controller 20, including configuring each DMA controller 34 for optimal performance for use in transferring various types of USB data.

It will be appreciated that any routines executed to implement any of the functionality utilized in the various embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, or any other programmable logic in a programmable electronic device, cause that computer or device to perform the steps necessary to execute steps or elements embodying the various aspects of the invention. Moreover, while the invention has and hereinafter will be described in the context of fully functioning computers and electronic devices, those skilled in the art will appreciate that the various embodiments of the invention are capable of being distributed as a program product in a variety of forms, and that the invention applies equally regardless of the particular type of signal bearing media used to actually carry out the distribution.

In addition, given the typically endless number of manners in which program functionality may be organized into routines, procedures, methods, modules, objects, and the like, as well as the various manners in which program functionality may be allocated among various software layers that are resident within a typical computer or electronic device (e.g., operating systems, libraries, APIs, applications, applets, etc.), it should be appreciated that the invention is not limited to the specific organization and allocation of program functionality described herein. Furthermore, the precise allocation of the herein-described functionality between hardware and software does not limit the invention, as different allocations may be used in other implementations.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

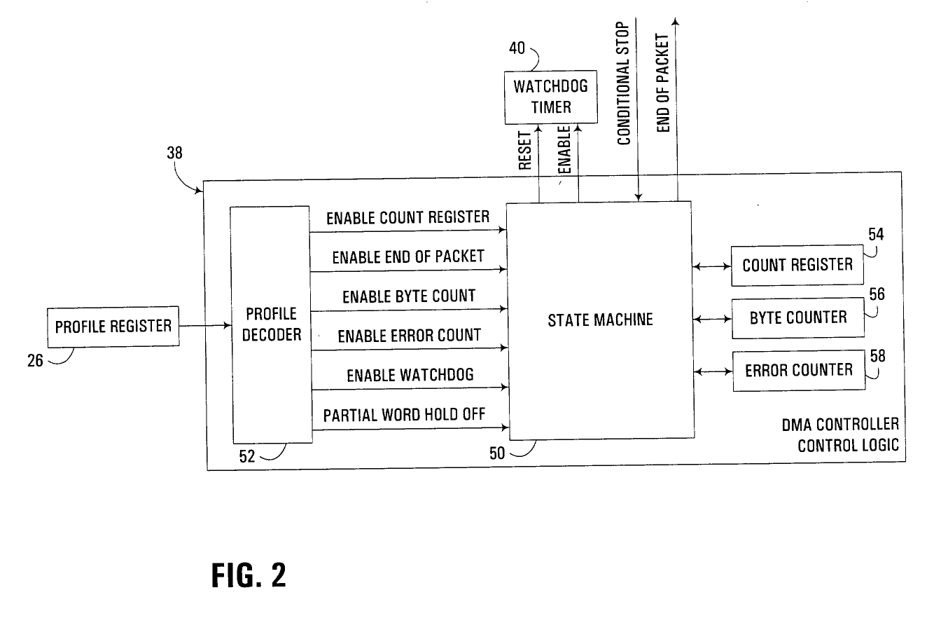

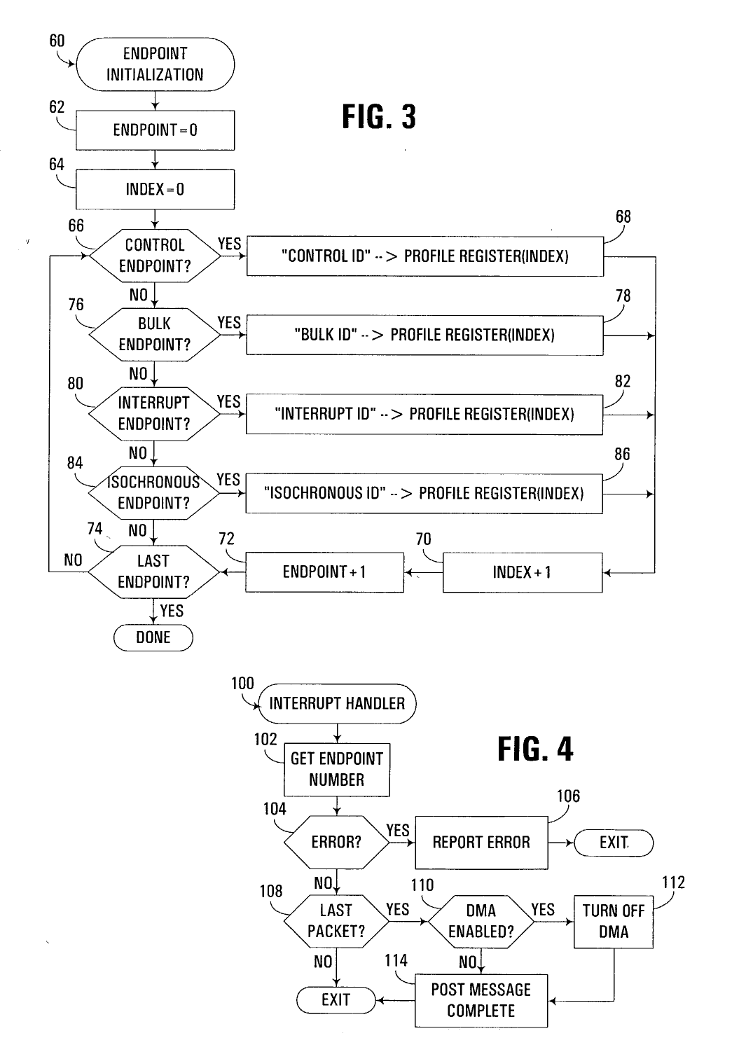

To provide optimal performance in a USB environment, USB controller, and in particular, each DMA control logic circuit therein, supports a number of enhancements to facilitate high-bandwidth data rates (e.g., the 192 Mb/s bandwidth supported by the USB 2.0 specification), as well as to both simplify and minimize software overhead. A number of these enhancements are illustrated in greater detail in FIG. 2, which illustrates an exemplary configuration of the DMA controller control logic 38 for one of the DMA channels of FIG. 1. It should be noted that the FIFO and the overall flow of data through the DMA channel has been omitted from FIG. 2.

In particular, each DMA control logic circuit includes a state machine 50 that is dynamically configurable by a profile decoder 52 that is fed a profile identifier from the associated profile register 26 for the DMA channel. The profile decoder generates a plurality of configuration signals, including an enable count register signal, an enable end of packet signal, an enable byte count signal, an enable error count signal, an enable watchdog signal, and a partial word hold off signal. In the alternative, the various signals provided by decoder may be mapped directly to individual bits in profile register 26, whereby profile decoder 52 would not be required. In that instance, it would be incumbent upon the USB driver to set the appropriate bits in profile register 26.

One enhancement to a conventional DMA controller is a DMA count register 54 that is capable of being selectively disabled, e.g., in response to the enable count register signal from decoder 52. Another enhancement, as noted above, is the endpoint watchdog timer 40, which may be enabled, for example, in response to an enable watchdog signal from decoder 52. When enabled (e.g., via an enable signal from state machine 50), the endpoint watchdog timer is reset in response to receipt of a data packet over the associated DMA channel (e.g., in response to a reset signal generated by state machine 50), such that, if no packet is received after a specified time, an interrupt is triggered and the retained partial word, if any, is optionally transferred. In an alternate implementation, watchdog timer 40 may be directly enabled via the enable watchdog signal from decoder 52, and the timer may directly monitor the DMA channel for data traffic.

Moreover, through the combination of a selectively-disabled count register, an endpoint watchdog timer, and an end of packet detection circuit in state machine 50, multiple DMA operational modes may be supported by each DMA control logic circuit. Moreover, the operational modes may be selected, for example, by the enable count register, enable end of packet and/or enable watchdog signals from decoder 52. The available modes are as follows:

Legacy Mode: DMA count register 54 is loaded with the number of bytes to be transferred. When the count is exhausted, the DMA control logic circuit is automatically disabled.

End of Packet Mode: The DMA control logic circuit, once enabled, transfers the entire contents of an incoming data packet. DMA count register 54 is disabled, and as such is essentially ignored. An end of packet detection circuit (e.g., in state machine 50) is used to signal an interrupt when an end of packet signal is received over the USB bus.

Continuous Mode: Once the DMA control logic circuit is enabled, it transfers incoming data until disabled by software. Again, DMA count register 54 is disabled. Moreover, the completion of data transfer may be detected by expiration of endpoint watchdog timer 40.

Another feature supported by each DMA control logic circuit is a partial word hold-off feature, which is enabled by the partial word hold-off signal from decoder 52, and which determines whether the number of bytes in an incoming data packet is a multiple of the DMA word length. If not, this feature holds off the final one word DMA transfer until more data is received, thus preventing invalid data from being transferred in the final word of a DMA transfer operation.

Additional features that may be supported include cross-packet boundary byte counters, conditional stops, and error counter registers. In particular, each DMA channel may include an associated cross-packet boundary byte counter 56 that is capable of being reset under software control, and that is used to accumulate the number of bytes received in every inbound data packet. The counter continues to accumulate until reset by software, which would enable, for example, the length of a multi-packet message to be tracked. Byte counter 56 may be enabled by the enable byte count signal generated by decoder 52.

Each DMA control logic circuit may also support conditional stops, whereby a DMA channel may be dynamically turned off under software control by setting a conditional stop function (e.g., via a conditional stop signal received by state machine 50). However, if a DMA transfer is in progress when the software sets the conditional stop function, the active transfer will complete the current packet before the control logic is shut off. Such a feature may be useful, for example, in connection with the continuous mode of operation, so that if the endpoint watchdog timer for a DMA channel generates an interrupt, any new data packet that arrives before the software can process the interrupt and shut off the DMA control circuit will be transmitted in full.

An error counter register 58 may also be associated with each DMA channel. Such a register is configured to be updated whenever the DMA control logic detects an error. Software may be used to reset the counter, and the counter may continue to count until reset. The detected errors include any and all problems associated with the DMA transfer of data, including, for example, overrun errors that can occur in association with the USB isochronous protocol. Error counter 58 may be enabled by the enable error count signal generated by decoder 52.

Furthermore, each DMA control logic circuit is desirably configured by a USB profile circuit including the aforementioned USB profile registers 26. The profile information stored in each profile register is based primarily upon the USB protocol that its associated DMA channel is servicing, such that the entire DMA Channel may be properly configured based upon the profile data stored in the register.

As such, typically the software utilizing the DMA control logic in a DMA channel need not understand the intricacies of setting up and handling the various communication protocols supported by the USB specification. The software need only specify the profile that matches the protocol supported by the endpoint along with the device interface type (memory or register based). The hardware may then be automatically configured from this one selection.

For example, a profile register may support the profiles shown below in Table I. It will be appreciated that other profile mappings may be used in the alternative. Moreover, it will be appreciated that various manners of encoding the profile information in a register may be used. For example, the 11 supported profiles may be encoded in a 4-bit register. In the alternative, each optional feature may be assigned one or more bits in a register, whereby the software would write an encoded value into the profile register to set all necessary profile options, as noted above.

TABLE I
PROFILE REGISTER MAPPING

| | | APPLICATION | |
|---|---|---|---|
| VALUE | PROTOCOL | INTERFACE | PROFILE CONTENTS |
| 1 | Control OUT | Memory | DMA End of Packet Mode, Cross-Packet |
| | | | Boundary Counter, Error Counter |
| 2 | Control IN | Memory | DMA Legacy Mode, Error Counter |
| 3 | Bulk OUT | Memory | DMA Legacy Mode, Partial Word Hold-off, |
| | | | Error Counter, Cross-Packet Boundary |
| | | | Counter, Watchdog Timer |
| 4 | Bulk IN | Memory | DMA Legacy Mode, Error Counter |
| 5 | Interrupt OUT | Memory | DMA Legacy Mode, Watchdog Timer, |
| | | | Partial Word Hold-off, Error Counter, Cross- |
| | | | Packet Boundary Counter |
| 6 | Interrupt OUT | Register/FIFO | DMA Continuous Mode, Error Counter |
| | | | Register Interrupt, Watchdog Timer |
| 7 | Interrupt IN | Memory <or> | DMA Legacy Mode, Error Counter |
| | | Register/FIFO | |
| 8 | Isochronous OUT | Memory | DMA Legacy Mode, Watchdog Timer, |
| | | | Partial Word Hold-off, Error Counter, Cross- |
| | | | Packet Boundary Counter |
| 9 | Isochronous OUT | Register/FIFO | DMA Continuous Mode, Error Counter |
| | | | Register Interrupt, Watchdog Timer |
| 10 | Isochronous IN | Memory | DMA Legacy Mode, Error Counter |
| 11 | Isochronous IN | Register/FIFO | DMA Continuous Mode, Error Counter |
| | | | Register Interrupt |

With respect to each profile, “Error Counter,” indicates that the error counter is enabled, while “Error Counter Register Interrupt” indicates that the error counter is enabled, and an interrupt will be triggered whenever the error counter is updated.

In the illustrated embodiment, when required, the DMA address register and the DMA count register are programmed separately from the profile register. Moreover, it may be desirable in some implementations to permit any or all of the registers in a DMA channel space to be overwritten after application of a profile via the profile register, in order to permit a particular profile to be customized via software control. In other implementations, no profile registers may be used, with each relevant feature and register set as appropriate for a particular USB protocol.

From the above table, it may be seen that the DMA continuous mode is utilized principally when the endpoint supports the isochronous protocol and data passes directly between the Endpoint FIFO and a device FIFO. In this mode, the DMA count register is disabled, and any errors get accumulated in the error counter register. Software can either poll the error counter register on a periodic basis or cause an interrupt to be triggered when the register is incremented. However, in this mode, it is desirable for errors to not cause the DMA control logic circuit to turn off. It may also be desirable for the partial word hold-off feature to be used if the device FIFO cannot accept partial word transfers. In addition, as noted in mode 9, it may be desirable to use the endpoint watchdog timer to detect a break in real-time traffic.

It may also be seen from above that the DMA end of packet mode is used principally for supporting the control protocol. In this environment, small packets of non-real-time information of often-indeterminate length are sporadically received. The DMA control logic circuit shuts off after receiving a single packet of any length. Neither the partial word hold-off feature nor the endpoint watchdog timer is needed or used, nor is the DMA count register. The cross-packet boundary byte counter may optionally be used to determine the number of bytes received in the packet, and the error counter register may be polled periodically or may generate interrupts in response to errors received during transmission of a data packet.

For all other modes, the DMA legacy mode may be used. For example, the DMA legacy mode may be useful when a mass storage (block) device receives data from an endpoint that supports the bulk transfer protocol. The DMA count register may be loaded with a multiple of the block size, with data from the individual packets written into the memory blocks. The number of packets required to fill the memory blocks, however, is transparent. When the specified number of blocks has been filled (i.e., the count register is exhausted), the DMA control logic circuit may shut off. It may be desirable to use the partial word hold-off feature to insure that invalid data gaps do not occur in the memory blocks. In addition, it may be desirable to use the endpoint watchdog timer to detect insufficient reception of data.

It will be appreciated that the implementation of the herein-described enhancements within DMA control logic would be well within the abilities of one of ordinary skill in the art having the benefit of the instant disclosure.

Software control of the herein-described enhanced DMA controller is typically, but not necessarily, managed by way of a USB driver, as noted above. FIG. 2, for example, illustrates an exemplary endpoint initialization routine 60 that may be executed by a USB driver to properly configure each endpoint of a USB controller for interaction with particular USB devices using optimal protocols for those devices.

Routine 60 begins in block 62 by resetting an endpoint variable to select the first endpoint supported by the controller. Block 64 then initializes an index variable to select the associated USB profile register for that endpoint.

Next, in block 66, it is determined whether the first endpoint should be configured as a control endpoint, e.g., based upon whether it is anticipated that the USB control protocol will be used to transmit data over the endpoint. If so, control passes to block 68 to set the profile register for that endpoint (selected via the index variable) to a control identification value that identifies the appropriate profile. Once set, control then passes to blocks 70 and 72 to increment the index and endpoint variables. Control then passes to block 74 to determine whether the last endpoint for the USB controller has been processed. If not, control passes to block 66 to process additional endpoints. Otherwise, routine 60 is complete.

Returning to block 66, it is determined that the next endpoint should not be configured as a control endpoint, control passes to block 76 to determine whether the endpoint should be configured as a bulk endpoint, e.g., based upon whether it is anticipated that the USB bulk protocol will be used to transmit data over the endpoint. If so, control passes to block 78 to set the profile register for that endpoint to a bulk identification value that identifies the appropriate profile. Once set, control then passes to blocks 70 and 72 to increment the index and endpoint variables, and then to block 74 to process all remaining endpoints, if any.

Next, returning to block 76, it is determined that the next endpoint should not be configured as a bulk endpoint, control passes to block 80 to determine whether the endpoint should be configured as an interrupt endpoint, e.g., based upon whether it is anticipated that the USB interrupt protocol will be used to transmit data over the endpoint. If so, control passes to block 82 to set the profile register for that endpoint to an interrupt identification value that identifies the appropriate profile. Once set, control then passes to blocks 70 and 72 to increment the index and endpoint variables, and then to block 74 to process all remaining endpoints, if any.

Next, returning to block 80, it is determined that the next endpoint should not be configured as an interrupt endpoint, control passes to block 84 to determine whether the endpoint should be configured as an isochronous endpoint, e.g., based upon whether it is anticipated that the USB isochronous protocol will be used to transmit data over the endpoint. If so, control passes to block 86 to set the profile register for that endpoint to an isochronous identification value that identifies the appropriate profile. Once set, control then passes to blocks 70 and 72 to increment the index and endpoint variables, and then to block 74 to process all remaining endpoints, if any.

To further initialize an endpoint for a DMA transfer, and as noted above, the USB driver separately configures the DMA address register to identify the appropriate source and/or destination for DMA transfers over the DMA channel. In addition, if the legacy mode is selected, the DMA count register is also set as appropriate. Once configured, the DMA controller for the DMA channel manages the transfer of data independently from the software, as with a conventional DMA controller.

FIG. 4 next illustrates an exemplary interrupt handler routine 100 that may be executed by a USB driver in response to an interrupt generated by a particular endpoint in the USB controller. Routine 100 begins in block 102 by obtaining the identity of the endpoint that generated the interrupt. Next, in block 104, it is determined whether an error was detected, e.g., via polling the error counter register in the DMA controller. If so, control passes to block 106 to report the error, such that the error will be handled as appropriate. Routine 100 is then complete.

Returning to block 104, if no error was detected, control passes to block 108 to determine whether the last data packet of a USB message has been received. In particular, routine 100 may poll the appropriate byte counter in the DMA controller to determine whether all of the data for a USB message has been received (e.g., as a result of the driver's tracking of an incoming message). If the last packet has not been received, routine 100 terminates. Otherwise, block 108 passes control to block 110 to determine if the DMA controller for the endpoint is still enabled. If so, block 110 passes control to block 112 to turn off the DMA controller (e.g., via assertion of a conditional stop signal). Control then passes to block 114 to post a “message complete” status such that other program code in the USB driver will undertake processing the message in a conventional manner. Routine 100 is then complete. Returning to block 110, if the DMA controller is not currently enabled, control passes directly to block 114 to post the “message complete” status, and terminate routine 100.

Various modifications may be made to the illustrated embodiments without departing from the spirit and scope of the invention. Therefore, the invention lies in the claims hereinafter appended.

What is claimed is:

1. A circuit arrangement, comprising:
(a) a direct memory access (DMA) control circuit configured to communicate data over at least one DMA channel; and
(b) a DMA count register configured to store a count value that controls the length of a data transfer over the DMA channel, wherein the DMA control circuit is configured to selectively disable the DMA count register and perform a data transfer independent of the DMA count register.

2. The circuit arrangement of claim 1, further comprising an endpoint watchdog timer coupled to the DMA control circuit and configured to generate an interrupt if no data is received by the DMA channel within a predetermined period of time.

3. The circuit arrangement of claim 1, wherein the DMA control circuit is configured to, when communicating a data packet over the DMA channel, delay transmission of a final word of data from the data packet if the final word is a partial word.

4. The circuit arrangement of claim 3, wherein the DMA control circuit is configured to delay transmission of the final word of data only when a partial word hold off mode is selected for the DMA control circuit.

5. The circuit arrangement of claim 1, further comprising an error counter register configured to log errors detected during transfer of data over the DMA channel.

6. The circuit arrangement of claim 1, wherein the DMA control circuit is configured to complete an in progress transfer of data from a data packet over the DMA channel prior to shutting off the DMA channel in response to receipt of a request to shut off the DMA channel.

7. The circuit arrangement of claim 6, wherein the request to shut off the DMA channel is a conditional stop request.

8. The circuit arrangement of claim 1, further comprising a byte counter configured to accumulate the amount of data transmitted over the DMA channel.

9. The circuit arrangement of claim 1, wherein the DMA control circuit is selectively operable in a count mode and a continuous mode, wherein in the count mode, the DMA control circuit enables the DMA count register, and in the continuous mode, the DMA control circuit disables the DMA count register.

10. The circuit arrangement of claim 9, wherein the DMA control circuit is selectively operable in an end of packet mode, wherein in the end of packet mode, the DMA control circuit disables the DMA count register and terminates a data transfer over the DMA channel in response to detection of an end of a data packet.

11. The circuit arrangement of claim 1, further comprising a Universal Serial Bus (USB) profile circuit coupled to the DMA control circuit and configured to control at least one operational parameter of the DMA control circuit to selectively optimize the DMA control circuit for use with a selected USB protocol among a plurality of USB protocols supported by the USB profile circuit.

12. The circuit arrangement of claim 1, further comprising a Universal Serial Bus (USB) endpoint coupled to the DMA control circuit, wherein the DMA control circuit is configured to control the transfer of data between the USB endpoint and a programmable electronic device.

13. The circuit arrangement of claim 1, wherein the DMA control circuit is configured to communicate data over a plurality of DMA channels, and wherein the circuit arrangement includes a plurality of DMA count registers respectively associated with the plurality of DMA channels, wherein each DMA count register is configured to be selectively disabled by the DMA control circuit during performance of a data transfer over the associated DMA channel.

14. A DMA controller comprising the circuit arrangement of claim 1.

15. A USB controller comprising the circuit arrangement of claim 1.

16. An integrated circuit comprising the circuit arrangement of claim 1.

17. A program product, comprising a hardware definition program defining the circuit arrangement of claim 1 and a signal bearing medium bearing the hardware definition program, wherein the signal bearing medium includes at least one of a recordable medium and a transmission medium.

18. A method of transferring data over a direct memory access (DMA) channel with a DMA control circuit, the method comprising:
(a) performing a first data transfer operation over the DMA channel by storing a count value in a DMA count register that controls the length of the first data transfer operation; and
(b) performing a second data transfer operation over the DMA channel by disabling the DMA count register such that the second data transfer operation is performed independent of the DMA count register.

19. The method of claim 18, wherein performing the second data transfer operation includes generating an interrupt with an endpoint watchdog timer coupled to the DMA control circuit if no data is received by the DMA channel within a predetermined period of time.

20. The method of claim 18, wherein performing the second data transfer operation includes transferring a data packet over the DMA channel, and delaying transmission of a final word of data from the data packet if the final word is a partial word.

21. The method of claim 18, wherein performing the second data transfer operation includes logging, to an error counter register, errors detected during transfer of data over the DMA channel.

22. The method of claim 18, wherein performing the second data transfer includes completing a transfer of data from a data packet over the DMA channel prior to shutting off the DMA channel in response to receipt of a request to shut off the DMA channel that is received prior to completion of the transfer of data from the data packet.

23. The method of claim 18, further comprising accumulating the amount of data transmitted over the DMA channel during performance of the first and second data transfer operations in a byte counter.

24. The method of claim 18, wherein performing the first data transfer operation includes configuring the DMA control circuit to operate in a count mode, and wherein performing the second data transfer operation includes configuring the DMA control circuit to operate in a continuous mode.

25. The method of claim 24, further comprising performing a third data transfer operation, including configuring the DMA control circuit to operate in an end of packet mode, and terminating the third data transfer operation in response to detection of an end of a data packet.

26. The method of claim 18, wherein performing the first and second data transfer operations each include transferring Universal Serial Bus (USB) data to or from a USB endpoint, the method further comprising controlling at least one operational parameter of the DMA control circuit using a USB profile circuit to selectively optimize the DMA control circuit for use with a selected USB protocol among a plurality of USB protocols supported by the USB profile circuit.

27. A circuit arrangement, comprising:
(a) a direct memory access (DMA) control circuit configured to communicate data over at least one DMA channel; and
(b) an endpoint watchdog timer coupled to the DMA control circuit and configured to generate an interrupt if no data is received by the DMA channel within a predetermined period of time.

28. The circuit arrangement of claim 27, wherein the endpoint watchdog timer is configured to be reset in response to a receipt of data by the DMA control circuit.

29. The circuit arrangement of claim 27, wherein the DMA control circuit is configured to selectively enable the endpoint watchdog timer.

30. A method of transferring data in a direct memory access (DMA) channel with a DMA control circuit, the method comprising:
(a) transferring data over the DMA channel;
(b) resetting an endpoint watchdog timer in response to a receipt of data for the DMA channel; and
(c) generating an interrupt with the endpoint watchdog timer if no data is received for the DMA channel within a predetermined period of time.

31. The method of claim 30, further comprising completing a transfer of a partial word of data in response to expiration of the endpoint watchdog timer.

32. A circuit arrangement, comprising a direct memory access (DMA) control circuit configured to communicate data over at least one DMA channel, wherein the DMA control circuit is configured to, when communicating a data packet over the DMA channel, delay transmission of a final word of data from the data packet if the final word is a partial word.

33. The circuit arrangement of claim 32, wherein the DMA control circuit is configured to delay transmission of the final word of data only if a partial word hold-off mode is enabled for the DMA control circuit.

34. The circuit arrangement of claim 32, wherein the DMA control circuit is configured to store data from a subsequent data packet in the final word prior to transmitting the final word over the DMA channel.

35. A method of transferring data in a direct memory access (DMA) channel with a DMA control circuit, the method comprising:
(a) transferring a data packet over the DMA channel; and
(b) delaying transmission of a final word of data form the data packet if the final word is a partial word.

36. A circuit arrangement, comprising:
(a) a direct memory access (DMA) control circuit configured to communicate data over at least one DMA channel; and
(b) a Universal Serial Bus (USB) profile circuit coupled to the DMA control circuit and configured to control at least one operational parameter of the DMA control circuit to selectively optimize the DMA control circuit for use with a selected USB protocol among a plurality of USB protocols supported by the USB profile circuit.

37. The circuit arrangement of claim 36, further comprising a DMA count register configured to store a count value that controls the length of a data transfer over the DMA channel, wherein the at least one operational parameter controlled by the USB profile circuit includes an enable/disable status for the DMA count register.

38. The circuit arrangement of claim 37, wherein the DMA control circuit is selectively operable in a count mode and a continuous mode, wherein in the count mode, the DMA control circuit enables the DMA count register, and in the continuous mode, the DMA control circuit disables the DMA count register, wherein the at least one operational parameter controlled by the USB profile circuit selects between the count and continuous modes.

39. The circuit arrangement of claim 38, wherein the DMA control circuit is selectively operable in an end of packet mode, wherein in the end of packet mode, the DMA control circuit disables the DMA count register and terminates a data transfer over the DMA channel in response to detection of an end of a data packet, wherein the at least one operational parameter controlled by the USB profile circuit selects between the end of packet, count and continuous modes.

40. The circuit arrangement of claim 36, further comprising an endpoint watchdog timer coupled to the DMA control circuit and configured to generate an interrupt if no data is received by the DMA channel within a predetermined period of time, wherein the at least one operational parameter controlled by the USB profile circuit includes an enable/disable status for the endpoint watchdog timer.

41. The circuit arrangement of claim 36, wherein the at least one operational parameter controlled by the USB profile circuit includes an enable/disable status for a partial word hold-off mode for the DMA control circuit, wherein when the partial word hold-off mode is enabled, the DMA control circuit is configured to, when communicating a data packet over the DMA channel, delay transmission of a final word of data from the data packet if the final word is a partial word.

42. The circuit arrangement of claim 36, further comprising an error counter register configured to log errors detected during transfer of data over the DMA channel, wherein the at least one operational parameter controlled by the USB profile circuit includes an enable/disable status for the error counter register.

43. The circuit arrangement of claim 36, further comprising a byte counter configured to accumulate the amount of data transmitted over the DMA channel, wherein the at least one operational parameter controlled by the USB profile circuit includes an enable/disable status for the byte counter.

44. The circuit arrangement of claim 36, wherein the plurality of USB protocols supported by the USB profile circuit include at least one of a control protocol, an interrupt protocol, an isochronous protocol and a bulk protocol.

45. The circuit arrangement of claim 36, wherein the USB profile circuit is further configured to control at least one operational parameter of the DMA control circuit to selectively optimize the DMA control circuit for use with a selected application interface, wherein the selected application interface is selected from among a memory and a register interface.

46. The circuit arrangement of claim 36, further comprising a Universal Serial Bus (USB) endpoint coupled to the DMA control circuit, wherein the DMA control circuit is configured to control the transfer of data between the USB endpoint and a programmable electronic device, and wherein the USB profile circuit is configured to optimize the USB endpoint.

47. The circuit arrangement of claim 36, wherein the DMA control circuit is configured to communicate data over a plurality of DMA channels, and wherein the USB profile circuit includes a plurality of profile registers, each profile register configured to control at least one operational parameter associated with an associated DMA channel from among the plurality of DMA channels.

48. The circuit arrangement of claim 36, wherein the USB profile circuit includes a profile register.

49. A DMA controller comprising the circuit arrangement of claim 36.

50. A USB controller comprising the circuit arrangement of claim 36.

51. An integrated circuit comprising the circuit arrangement of claim 36.

52. A program product, comprising a hardware definition program defining the circuit arrangement of claim 36 and a signal bearing medium bearing the hardware definition program, wherein the signal bearing medium includes at least one of a recordable medium and a transmission medium.

53. A method of transferring data in a direct memory access (DMA) channel with a DMA control circuit, the method comprising:
(a) dynamically configuring, with a Universal Serial Bus (USB) profile circuit coupled to the DMA control circuit, at least one operational parameter of the DMA control circuit to optimize the DMA control circuit for use with a selected USB protocol among a plurality of USB protocols; and
(b) performing a data transfer operation to transfer USB data over the DMA channel while the DMA control circuit is dynamically configured by the USB profile circuit.
